(19) United States
(12) Patent Application Publication
(10) Pub. No.: US 2026/0161375 A1
(43) Pub. Date: Jun. 11, 2026

(54) SCRIPT ORCHESTRATOR FOR CLOUD INFRASTRUCTURE DEPLOYMENT

(71) Applicant: BANK OF AMERICA CORPORATION, Charlotte, NC (US)

(72) Inventors: Ismail Mumin, Roswell, GA (US); Kiran Boosetty, Saint Johns, FL (US)

(73) Assignee: BANK OF AMERICA CORPORATION, Charlotte, NC (US)

(21) Appl. No.: 18/941,033

(22) Filed: Nov. 8, 2024

(51) Int. Cl. G06F 8/60; G06F 8/71; G06F 9/445; H04L 67/10

(52) U.S. Cl. CPC G06F 8/60; G06F 8/71; G06F 9/44505; H04L 67/10

(57) ABSTRACT

Embodiments of the invention are directed to systems, methods, and computer program products for orchestrating scripts for cloud deployment. The invention includes receiving one or more configuration parameters associated with a cloud deployment process and based on the one or more configuration parameters, importing one or more first code bases from a remote repository. The invention further includes launching a remote workspace, executing the one or more first code bases in the remote workspace, identifying a second code base associated with the cloud deployment process, and executing the cloud deployment process by executing the second code base in a local workspace, where an input of the second code base is the stored output.

### TECHNOLOGICAL FIELD

Example embodiments of the present disclosure relate to a system for orchestrating scripts for cloud infrastructure deployment.

### BACKGROUND

In conventional systems for cloud infrastructure deployment, deploying multiple cloud configurations requires operating multiple remote workspaces sequentially, which is a resource-intensive process prone to error. As such, there is a need for a system for automatically orchestrating multiple scripts to automate the cloud infrastructure deployment process.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the invention relate to systems, methods, and computer program products for technical architecture integration, the invention including: using a data intake module, receiving one or more configuration parameters associated with a cloud deployment process; based on the one or more configuration parameters, importing one or more first code bases from a remote repository, where the one or more first code bases comprise a first programming language; launching a remote workspace; and executing the one or more first code bases in the remote workspace, where executing the one or more first code bases in the remote workspace includes generating an output and storing the output in a local repository. The invention may further include identifying a second code base associated with the cloud deployment process, where the second code base comprises a second programming language different from the first programming language and executing the cloud deployment process by executing the second code base in a local workspace, where an input of the second code base is the stored output.

In some embodiments, executing the one or more first code bases in the remote workspace further includes executing each first code base of the one or more first code bases; generating a state file associated with each executed code base; and storing the state file in the local repository.

In some embodiments, the invention further includes generating a key value pair associated with the stored state file, where the key value pair associates a variable of the second code base with a value in the stored state file.

In some embodiments, the first programming language is a configuration language and the second programming language is a general-purpose programming language.

In some embodiments, importing the one or more first code bases further includes building a query based on the one or more configuration parameters and selecting the one or more first code bases from the remote repository based on the query.

In some embodiments, the stored output is associated with an activation status of a cloud infrastructure component.

In some embodiments, executing the cloud deployment process further includes changing the activation status of the cloud infrastructure component.

In some embodiments, the cloud infrastructure component comprises at least one virtual network switch.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates technical components of a system for orchestrating scripts for cloud deployment, in accordance with one embodiment of the present disclosure;

FIG. 2 is a block diagram illustrating the system for orchestrating scripts for cloud deployment, in accordance with one embodiment of the present disclosure; and

FIG. 3 illustrates a process flow for orchestrating scripts for cloud deployment, in accordance with one embodiment of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

As used herein, an “entity” may be any institution utilizing large-scale computer systems, particularly computer systems which interact with multiple other systems. Typically, these systems can be related to an organizational function of the entity, its products or services, data maintenance, or any other aspect of the operations of the organization. As such, the entity may be any institution, group, association, financial institution, establishment, company, union, authority or the like, utilizing large-scale computer systems to perform a function.

As used herein, a “user interface” may be any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, an “engine” may refer to core elements of a computer program, or part of a computer program that serves as a foundation for a larger piece of software and drives the functionality of the software. An engine may be self-contained, but externally-controllable code that encapsulates powerful logic designed to perform or execute a specific type of function. In one aspect, an engine may be underlying source code that establishes file hierarchy, input and output methods, and how a specific part of a computer program interacts or communicates with other software and/or hardware. The specific components of an engine may vary based on the needs of the specific computer program as part of the larger piece of software. In some embodiments, an engine may be configured to retrieve resources created in other computer programs, which may then be ported into the engine for use during specific operational aspects of the engine. An engine may be configurable to be implemented within any general purpose computing system. In doing so, the engine may be configured to execute source code embedded therein to control specific features of the general purpose computing system to execute specific computing operations, thereby transforming the general purpose system into a specific purpose computing system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, and/or one or more devices, nodes, clusters, or systems within the system environment described herein. For example, an interaction may refer to a transfer of data between devices, an accessing of stored data by one or more nodes of a computing cluster, a transmission of a requested task, or the like.

As used herein, “production environment” includes various components used to deploy, implement, access, and use, a given application as that application is intended to be used. In various embodiments, production environments include multiple production environment components that are combined; communicatively coupled; virtually and/or physically connected; and/or associated with one another, to provide the production environment implementing the application. In some embodiments, the production environment components making up a given production environment can include, but are not limited to, one or more computing environments used to implement the application in the production environment such as a data center, a cloud computing environment, and/or one or more other computing environments in which one or more components and/or services used by the application in the production environment are implemented; one or more computing systems or computing entities used to implement the application in the production environment; one or more supervisory or control systems, such as hypervisors, used to implement the application in the production environment; one or more communications channels used to implement the application in the production environment; one or more access control systems, such as firewalls and gateways, used to implement the application in the production environment; one or more routing systems, such as routers and switches, used to implement the application in the production environment; one or more communications endpoint proxy systems, such as load balancers or buffers, used to implement the application in the production environment; one or more traffic or access control systems used to implement the application in the production environment; one or more secure communication protocols and/or endpoints, such as Secure Sockets Layer (SSL) protocols, used to implement the application in the production environment; one or more databases used to implement the application in the production environment; one or more internal or external services used to implement the application in the production environment; one or more backend systems, such as backend servers or other hardware used to implement the application in the production environment; one or more software systems used to implement the application in the production environment; and/or any other components making up an actual production environment in which an application is to be deployed, implemented, accessed, and run, as discussed herein, and/or as known in the art at the time of filing, and/or as developed after the time of filing.

As used herein, “code base” refers to a collection of source code written in a single programming language. In some examples, a code base may comprise all of the source code for a computer program. A code base may be understood to comprise discrete “modules,” which may be objects, classes, interfaces, methods, subroutines, etc., with each module providing discrete functionality in terms of the code base. A code base may further refer to a complete collection of source code for compiling (or interpreting) an application, software, software component, and/or the like.

As used herein, “cloud infrastructure” may refer to one or more virtual machines in which a code base is executed, as well as various virtual devices such as virtual network switches and virtual data storage devices that the virtual machines access while executing a code base. “Cloud infrastructure deployment” or “cloud deployment” may refer to a process of defining a topology of a multi-cloud virtual computing environment for an application, such that the components of the application are able to operate in a unified manner.

In conventional systems for cloud infrastructure deployment, deploying multiple cloud configurations is a resource-intensive process, because configuration languages such as Terraform do not provide native processes for deploying multiple configurations in a single workspace. Additionally, there are no native processes available to pass through outputs between workspaces or between programming languages. As such, the present invention provides a solution which seamlessly operates between a first script running on a remote workspace in a first programming language and a second script running on a local workspace in a second programming language. To achieve this solution, the present invention may be embodied as a self-contained software package installed on an end-point device. The invention may automate the deployment of multiple cloud configurations by executing multiple code bases in sequence in a single remote workspace and may dynamically pass outputs from one aspect of the sequence to another. Thus, the present invention consolidates the infrastructure deployment workload, reducing the computational resources required to host multiple remote workspaces.

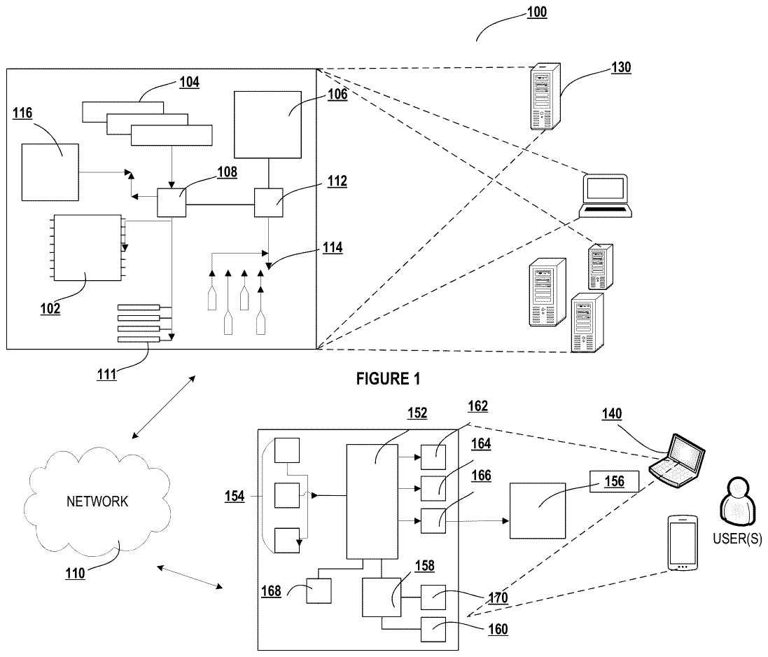

FIG. 1 presents an exemplary block diagram of a system environment 100, in accordance with an embodiment of the invention. FIG. 1 provides a unique system that includes specialized servers and system communicably linked across a distributive network of nodes required to perform the functions of the process flows described herein in accordance with embodiments of the present invention.

As illustrated, the system environment 100 includes a network 110, a system 130, and a user input system 140. Also shown in FIG. 1 is one or more user(s) of the user input system 140. The user input system 140 is intended to represent various forms of mobile devices, such as laptops, personal digital assistants, augmented reality (AR) devices, virtual reality (VR) devices, extended reality (XR) devices, and/or the like, and non-mobile devices such as desktops, video recorders, audio/video player, radio, workstations, and/or the like. The user may be a person who uses the user input system 140 to execute one or more processes described herein using one or more applications stored thereon. The one or more applications may be configured to communicate with the system 130, execute a process or method, input information onto a user interface presented on the user input system 140, or the like. The applications stored on the user input system 140 and the system 130 may incorporate one or more parts of any process flow described herein.

As shown in FIG. 1, the system 130, and the user input system 140 are each operatively and selectively connected to the network 110, which may include one or more separate networks. In addition, the network 110 may include a telecommunication network, local area network (LAN), a wide area network (WAN), and/or a global area network (GAN), such as the Internet. It will also be understood that the network 110 may be secure and/or unsecure and may also include wireless and/or wired and/or optical interconnection technology.

In some embodiments, the system 130 and the user input system 140 may be used to implement the processes described herein, including the mobile-side and server-side processes for installing a computer program from a mobile device to a computer, in accordance with an embodiment of the present invention. The system 130 is intended to represent various forms of digital computers, such as laptops, desktops, workstations, electronic kiosk devices, blade servers, mainframes, or any combination of the aforementioned. The user input system 140 is intended to represent various forms of personal devices, such as laptops, desktops, mobile devices, smartphones, and other similar computing devices. The components shown here, their connections and relationships, and their functions, are meant to be exemplary only, and are not meant to limit implementations of the inventions described and/or claimed in this document.

In accordance with some embodiments, the system 130 may include a processor 102, memory 104, a storage device 106, a high-speed interface 108 connecting to memory 104, and a low-speed interface 112 connecting to low speed bus 114 and storage device 106. Each of the components 102, 104, 106, 108, 111, and 112 are interconnected using various buses, and may be mounted on a common motherboard or in other manners as appropriate. The processor 102 can process instructions for execution within the system 130, including instructions stored in the memory 104 or on the storage device 106 to display graphical information for a GUI on an external input/output device, such as display 116 coupled to a high-speed interface 108. In other implementations, multiple processors and/or multiple buses may be used, as appropriate, along with multiple memories and types of memory. Also, multiple systems, same or similar to system 130 may be connected, with each system providing portions of the necessary operations (e.g., as a server bank, a group of blade servers, or a multi-processor system). In some embodiments, the system 130 may be a server managed by an entity. The system 130 may be located at a facility associated with the entity or remotely from the facility associated with the entity.

The memory 104 stores information within the system 130. In one implementation, the memory 104 is a volatile memory unit or units, such as volatile random access memory (RAM) having a cache area for the temporary storage of information. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, it appears as though the memory is being allocated from a central pool of memory, even though the space is distributed throughout the system. This method of dynamically allocating memory provides increased flexibility when the data size changes during the lifetime of an application and allows memory reuse for better utilization of the memory resources when the data sizes are large.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms, as shown in FIG. 1. For example, it may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 140 may be made up of multiple computing devices communicating with each other.

FIG. 1 also illustrates a user input system 140, in accordance with an embodiment of the invention. The user input system 140 includes a processor 152, memory 154, an input/output device such as a display 156, a communication interface 158, and a transceiver 160, among other components. The user input system 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the user input system 140, including instructions stored in the memory 154. The processor may be implemented as a chipset of chips that include separate and multiple analog and digital processors. The processor may be configured to provide, for example, for coordination of the other components of the user input system 140, such as control of user interfaces, applications run by user input system 140, and wireless communication by user input system 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of user input system 140 with other devices. External interface 168 may provide, for example, for wired communication in some implementations, or for wireless communication in other implementations, and multiple interfaces may also be used.

The memory 154 stores information within the user input system 140. The memory 154 can be implemented as one or more of a computer-readable medium or media, a volatile memory unit or units, or a non-volatile memory unit or units. Expansion memory may also be provided and connected to user input system 140 through an expansion interface (not shown), which may include, for example, a SIMM (Single In Line Memory Module) card interface. Such expansion memory may provide extra storage space for user input system 140, or may also store applications or other information therein. In some embodiments, expansion memory may include instructions to carry out or supplement the processes described above, and may include secure information also. For example, expansion memory may be provided as a security module for user input system 140, and may be programmed with instructions that permit secure use of user input system 140. In addition, secure applications may be provided via the SIMM cards, along with additional information, such as placing identifying information on the SIMM card in a non-hackable manner. In some embodiments, the user may use the applications to execute processes described with respect to the process flows described herein. Specifically, the application executes the process flow discussed in greater detail with respect to FIG. 4. It will be understood that the one or more applications stored in the system 130 and/or the user computing system 140 may interact with one another and may be configured to implement any one or more portions of the various user interfaces and/or process flow described herein.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the user input system 140 to transmit and/or receive information or commands to and from the system 130. In this regard, the system 130 may be configured to establish a communication link with the user input system 140, whereby the communication link establishes a data channel (wired or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, or the like.

The user input system 140 may communicate with the system 130 (and one or more other devices) wirelessly through communication interface 158, which may include digital signal processing circuitry where necessary. Communication interface 158 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 160. In addition, short-range communication may occur, such as using a Bluetooth, Wi-Fi, or other such transceiver (not shown). In addition, GPS (Global Positioning System) receiver module 170 may provide additional navigation-and location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker, e.g., in a handset of user input system 140. Such sound may include sound from voice telephone calls, may include recorded sound (e.g., voice messages, music files, etc.) and may also include sound generated by one or more applications operating on the user input system 140, and in some embodiments, one or more applications operating on the system 130.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

It will be understood that the embodiment of the system environment illustrated in FIG. 1 is exemplary and that other embodiments may vary. As another example, in some embodiments, the system 130 includes more, less, or different components. As another example, in some embodiments, some or all of the portions of the system environment 100 may be combined into a single portion. Likewise, in some embodiments, some or all of the portions of the system 130 may be separated into two or more distinct portions.

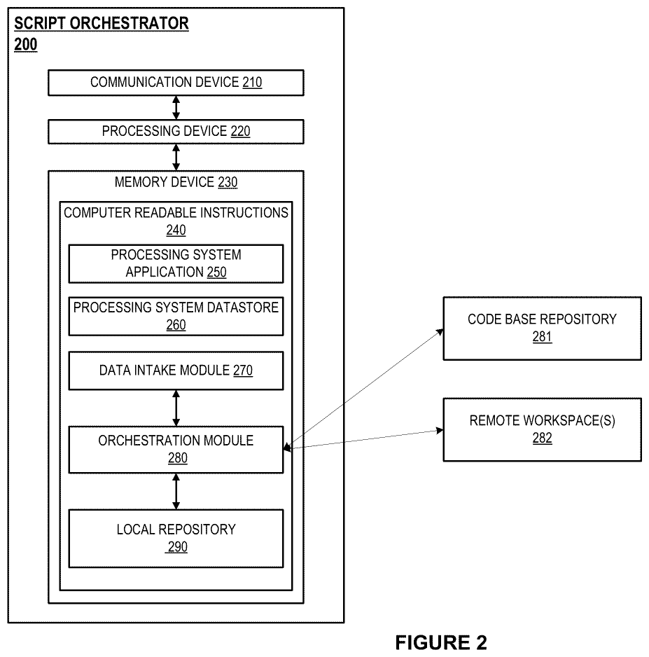

FIG. 2 illustrates a block diagram of a script orchestrator 200 associated with the system environment 100, in accordance with embodiments of the present invention. In some embodiments, the script orchestrator may comprise a software package installed on an end-point device of the system environment 100. As illustrated in FIG. 2, the script orchestrator 200 may include a communication device 210, a processing device 220, and a memory device 230 having a data intake module 270, an orchestration module 280, a local repository 290, a processing system application 250 and a processing system datastore 260 stored therein. As shown, the processing device 220 is operatively connected to and is configured to control and cause the communication device 210 and the memory device 230 to perform one or more functions. In some embodiments, the data intake module 270, orchestration module 280, and/or the processing system application 250 comprise computer readable instructions 240 that when executed by the processing device 220 cause the processing device 220 to perform one or more functions and/or transmit control instructions to other systems, applications, and/or devices in the system environment 100. It will be understood that the data intake module 270, orchestration module 280, and/or the processing system application 250 may be executable to initiate, perform, complete, and/or facilitate one or more portions of any embodiments described and/or contemplated herein.

The data intake module 270 may be configured to receive structured and/or unstructured data inputs from a user of the end-point device via a user interface. In some embodiments, the data intake module 270 may be configured to establish communication channels with one or more modules or devices for the receipt of structured and/or unstructured data inputs. In some embodiments, the data intake manager 270 may be further configured to perform a series of data processing steps, such as converting data from a first format to a second format, inputting data into a natural language processing engine, and/or the like.

The orchestration module 280 may be configured to communicate with a remote code base repository 281 and may be further configured to launch one or more remote workspace(s) 282. The code base repository 281 may comprise software installed on a remote server for storing a plurality of code bases. The code base repository 281 may also store all traditional source code documentation for understanding of the code bases, including written text, images, and the like. The orchestration module 28 may be configured to access code bases from the code base repository 281 in response to a query or command, such as a “get” command. The code bases stored by the code base repository 281 may be stored in an encrypted or unencrypted form. The remote workspace(s) 282 may represent one or more virtual workspaces which may be hosted by a remote server. The script orchestrator 200 may be configured to launch one or more remote workspace(s) on an end-point device and may configured to execute scripts and/or code bases within the remote workspace(s). The orchestration module 280 may further store instructions and/or data that may cause or enable the script orchestrator 200 to receive, store, and/or analyze data received from the data intake module 270, the local repository 290, and/or the processing system datastore 260.

The communication device 210 may generally include a modem, server, transceiver, and/or other devices for communicating with other devices on the network 101. The communication device 210 may be a communication interface having one or more communication devices configured to communicate with one or more other devices on the network 101.

Additionally, referring to the script orchestrator 200 illustrated in FIG. 2, the processing device 220 may generally refer to a device or combination of devices having circuitry used for implementing the communication and/or logic functions of the multilayer decisioning system 200. For example, the processing device 220 may include a control unit, a digital signal processor device, a microprocessor device, and various analog-to-digital converters, digital-to-analog converters, and other support circuits and/or combinations of the foregoing. Control and signal processing functions of the script orchestrator 200 may be allocated between these processing devices according to their respective capabilities. The processing device 220 may further include functionality to operate one or more software programs based on computer-executable program code 240 thereof, which may be stored in a memory device 230, such as the processing system application 250, the data intake manager 270, and/or the orchestration module 280. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 220 may be configured to use the network communication interface of the communication device 210 to transmit and/or receive data and/or commands to and/or from the other devices/systems connected to the network 101.

The memory device 230 within the multilayer decisioning system 200 may generally refer to a device or combination of devices that store one or more forms of computer-readable media for storing data and/or computer-executable program code/instructions. For example, the memory device 230 may include any computer memory that provides an actual or virtual space to temporarily or permanently store data and/or commands provided to the processing device 220 when it carries out its functions described herein. As used herein, memory may include any computer readable medium configured to store data, code, or other information. The memory device 350 may include volatile memory, such as volatile Random Access Memory (RAM) including a cache area for the temporary storage of data. The memory device 420 may also include non-volatile memory, which can be embedded and/or may be removable. The non-volatile memory may additionally or alternatively include an electrically erasable programmable read-only memory (EEPROM), flash memory or the like.

In some instances, various features and functions of the invention are described herein with respect to a “system.” In some instances, the system may refer to the script orchestrator 200 performing one or more steps described herein in conjunction with other devices and systems, either automatically based on executing computer readable instructions of the memory device 230, or in response to receiving control instructions from another device in the system environment 100. In some instances, the system refers to the devices and systems on the system environment 100 of FIG. 1. The features and functions of various embodiments of the invention are be described below in further detail. It is understood that the servers, systems, and devices described herein illustrate one embodiment of the invention. It is further understood that one or more of the servers, systems, and devices can be combined in other embodiments and still function in the same or similar way as the embodiments described herein.

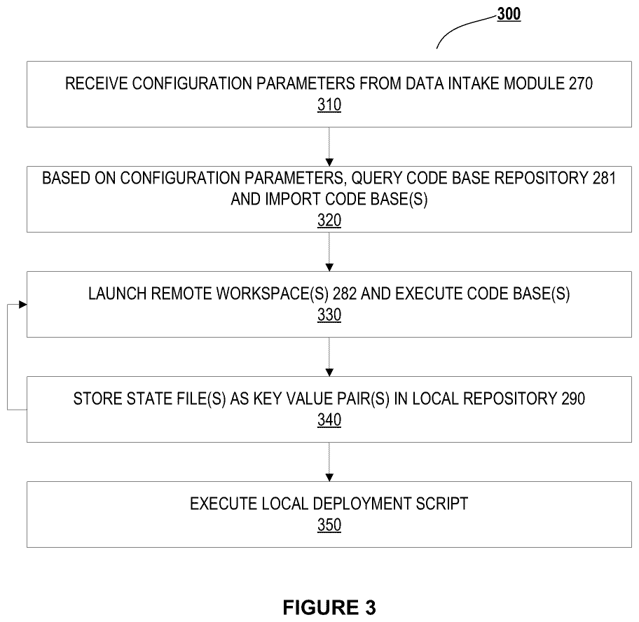

FIG. 3 is a high-level process flow diagram illustrating a process 300 using the script orchestrator 200, in accordance with some embodiments. The process may begin at block 310, where the system is configured to receive, via the data intake module 270, a set of configuration parameters associated with a cloud deployment process. In some embodiments, the configuration parameters may define various combinations of cloud resources, such that each set of configuration parameters defines a unique cloud infrastructure pattern. In some embodiments, the configuration parameters may be received as an unstructured input, and the data intake manager 270 may be configured to convert the unstructured input to a standard format.

The process may then continue to block 320, where the system is configured to build a query based on the one or more configuration parameters. For example, the query may define a code base associated with each cloud resource identified in the configuration parameters. The system may then query the code base repository 281 and import and/or download one or more code bases based on the query. In some embodiments, the code bases imported from the code base repository 281 may be in a configuration language, such as Terraform, Dhall, JSON, Pkl, and/or the like.

The process may continue to block 330, where the system is configured to a launch a remote workspace 282, as described in greater detail with respect to FIG. 2. The system may then execute one of the imported code bases in the remote workspace 282, thereby generating a state version associated with the cloud resources defined in the code base. For example, the state version may indicate an activation and/or deployment status of a cloud resource and/or cloud infrastructure component such as a network device, network switch, storage device, or the like.

The process flow may then continue to block 340, where the system may, through an Application Programming Interface (API) of the remote workspace, store the state version as a state file. The state file may be stored in a text-based format such as JSON or the like. In some embodiments, the state file may be saved as a set of key value pairs, where values of the state file are matched to named variables. Additionally or alternatively, the state file may comprise a unique identification code associated with the executed code base. In some embodiments, the state file may be stored in the local repository 290. The process flow may then return to block 330, where the system may clear the state version of the remote workspace 282 and run another imported code base, generating a new state version. The process flow may iterate until a state file is stored for each code base of the set of imported code bases. After storing each state file, the state version may be cleared using a command line interface (CLI) of the remote workspace 282.

The process flow may then continue to block 350, where the system is configured to identify and execute a local deployment script. In some embodiments, the local deployment script may be stored in the local repository 290. The local deployment script may comprise a code base in a general-purpose programming language, such as Python, Java, C++, and/or the like. The local deployment script may be configured to add flexibility to a cloud infrastructure deployment by incorporating additional logic based on the configuration parameters. For example, the local deployment script may activate and/or deactivate particular cloud resources based on logical outputs. In some embodiments, the system may be configured to execute the local deployment script in a local workspace of the system. The local deployment script may identify named variables, and the system may be configured to automatically pass through the stored values of the key value pairs associated with each named variable. The local deployment script may further cause the system to execute the cloud infrastructure deployment process.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for orchestrating scripts for cloud deployment, the system comprising:
at least one non-transitory storage device; and
at least one processing device coupled to the at least one non-transitory storage device, wherein the at least one processing device is configured to:
using a data intake module, receive one or more configuration parameters associated with a cloud deployment process;
based on the one or more configuration parameters, import one or more first code bases from a remote repository, wherein the one or more first code bases comprise a first programming language;
launch a remote workspace;
execute the one or more first code bases in the remote workspace, wherein executing the one or more first code bases in the remote workspace comprises:
generating an output; and
storing the output in a local repository;
identify a second code base associated with the cloud deployment process, wherein the second code base comprises a second programming language different from the first programming language; and
execute the cloud deployment process by executing the second code base in a local workspace, wherein an input of the second code base is the stored output.

2. The system of claim 1, wherein executing the one or more first code bases in the remote workspace further comprises:
executing each first code base of the one or more first code bases;
generating a state file associated with each executed code base; and
storing the state file in the local repository.

3. The system of claim 2, wherein the at least one processing device is further configured to:
generate a key value pair associated with the stored state file, wherein the key value pair associates a variable of the second code base with a value in the stored state file.

4. The system of claim 1, wherein the first programming language comprises a configuration language and the second programming language comprises a general-purpose programming language.

5. The system of claim 1, wherein importing the one or more first code bases further comprises:
building a query based on the one or more configuration parameters; and
selecting the one or more first code bases from the remote repository based on the query.

6. The system of claim 1, wherein the stored output is associated with an activation status of a cloud infrastructure component.

7. The system of claim 6, wherein executing the cloud deployment process further comprises changing the activation status of the cloud infrastructure component.

8. The system of claim 6, wherein the cloud infrastructure component comprises at least one virtual network switch.

9. A computer program product for orchestrating scripts for cloud deployment, the computer program product comprising a non-transitory computer-readable medium comprising code causing an apparatus to:
using a data intake module, receive one or more configuration parameters associated with a cloud deployment process;
based on the one or more configuration parameters, import one or more first code bases from a remote repository, wherein the one or more first code bases comprise a first programming language;
launch a remote workspace;
execute the one or more first code bases in the remote workspace, wherein executing the one or more first code bases in the remote workspace comprises:
generating an output; and
storing the output in a local repository;
identify a second code base associated with the cloud deployment process, wherein the second code base comprises a second programming language different from the first programming language; and
execute the cloud deployment process by executing the second code base in a local workspace, wherein an input of the second code base is the stored output.

10. The computer program product of claim 9, wherein executing the one or more first code bases in the remote workspace further comprises:
executing each first code base of the one or more first code bases;
generating a state file associated with each executed code base; and
storing the state file in the local repository.

11. The computer program product of claim 10, wherein the apparatus is further configured to generate a key value pair associated with the stored state file, wherein the key value pair associates a variable of the second code base with a value in the stored state file.

12. The computer program product of claim 9, wherein the first programming language comprises a configuration language and the second programming language comprises a general-purpose programming language.

13. The computer program product of claim 9, wherein importing the one or more first code bases further comprises:
building a query based on the one or more configuration parameters; and
selecting the one or more first code bases from the remote repository based on the query.

14. The computer program product of claim 9, wherein the stored output is associated with an activation status of a cloud infrastructure component.

15. The computer program product of claim 14, wherein executing the cloud deployment process further comprises changing the activation status of the cloud infrastructure component.

16. The computer program product of claim 14, wherein the cloud infrastructure component comprises at least one virtual network switch.

17. A computer-implemented method for orchestrating scripts for cloud deployment, the method comprising:
using a data intake module, receiving one or more configuration parameters associated with a cloud deployment process;
based on the one or more configuration parameters, importing one or more first code bases from a remote repository, wherein the one or more first code bases comprise a first programming language;
launching a remote workspace;
executing the one or more first code bases in the remote workspace, wherein executing the one or more first code bases in the remote workspace comprises:
generating an output; and
storing the output in a local repository;
identifying a second code base associated with the cloud deployment process, wherein the second code base comprises a second programming language different from the first programming language; and
executing the cloud deployment process by executing the second code base in a local workspace, wherein an input of the second code base is the stored output.

18. The method of claim 17, wherein executing the one or more first code bases in the remote workspace further comprises:
executing each first code base of the one or more first code bases;
generating a state file associated with each executed code base; and
storing the state file in the local repository.

19. The method of claim 18, further comprising:
generating a key value pair associated with the stored state file, wherein the key value pair associates a variable of the second code base with a value in the stored state file.

20. The method of claim 19, wherein the stored output is associated with an activation status of a cloud infrastructure component and wherein executing the cloud deployment process further comprises changing the activation status of the cloud infrastructure component.
